(19) United States
(12) Patent Application Publication
(10) Pub. No.: US 2007/0105415 A1
(43) Pub. Date: May 10, 2007

(54) Power connector with automatic power control

(76) Inventors: Yucheng Jin, Chalfont, PA (US); Jeffrey D. Ollis, Dresher, PA (US); Daniel P. Quigley, Woodinville, WA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/268,211

(22) Filed: Nov. 7, 2005

(51) Int. Cl. H01R 25/00

(52) U.S. Cl. 439/122

(57) ABSTRACT

A smart connector is provided by a jack that is removably engagable with a respective mateable plug to establish a power path between an external power supply and a circuit in an electronic device when the jack and mateable plug are mateably engaged. In an illustrative example, the jack functions as the DC power jack for the electronic device and the mateable plug is disposed in the power adapter plug of an AC-DC power adapter. A voltage sensor coupled to the jack compares the voltage supplied by the power supply against a reference that defines a power level that will operate the electronic device without causing damage. A power controller, coupled to the voltage sensor, controls the flow of power to the circuit in response to a control signal generated by the voltage sensor. In various illustrative embodiments, the power controller includes current limiting, voltage clamping and/or switching functions.

### FIELD OF THE INVENTION

This invention is related generally to connectors for use with electronic devices, and more particularly to a power connector with automatic power control.

### BACKGROUND OF THE INVENTION

Many modern consumer or office electronics use AC-DC power supplies as a power source to operate the electronic device or recharge an internally-contained battery. AC-DC power supplies (which are often referred to as “AC-DC power adapters”) take AC electrical power, for example from a wall outlet, and convert it to DC power for use by the electronic device. Electronic devices sold in the market today have widely diverse requirements for the DC power supplied by the AC-DC power adapter in terms of voltage and current. For example, common voltage ratings for AC-DC power adapters include 5 VDC, 6 VDC, 7.5 VDC, 9 VDC, 12 VDC, 15 VDC, etc. Common current ratings for AC-DC power adapters are 500 mA, 1A, 2A, etc. In addition, polarity requirements for the supplied DC power vary among electronic devices.

FIG. 1 is a diagram of a typical AC-DC power adapter arrangement 100 and an electronic device 114. AC-DC power adapter 100 includes an AC-DC power adapter body 102, AC electrical plug 104 and power adapter plug 108. AC-DC power adapter 100 is arranged so that the AC electrical plug 104 takes AC power, for example from a wall outlet (not shown) at 110 VAC, and converts it to DC power in the power adapter body 102 which is then supplied at power adapter plug 108. The supplied DC power has specifications (i.e., voltage, current and polarity) that are intended by the manufacturer to be appropriate for the power requirements of a specific electronic device. Electronic device 114, as shown in FIG. 1, includes a DC power jack 118 that is arranged to receive power adapter plug 108 to thereby take DC power from the AC-DC power adapter 100 and deliver it to the electronic device 114.

A common problem is that a user may easily, but mistakenly, connect an incompatible AC-DC power adapter to an electronic device. In other words, the user may accidentally plug an AC-DC power adapter into an electronic device for which it is not designed to work, even though the AC-DC power adapter appears outwardly to be the correct one and indeed may have a power adapter plug that may be readily plugged into the electronic device's DC power jack.

Such problems occur for a number of reasons. The power adapter plugs commonly used with AC-DC power adapter often look the same and physically interact in a similar manner with the corresponding DC power jack in the electronic device. For example, the Switchcraft brand 765/712 type two-conductor connector set is widely used in the electronics industry. The cylindrical plug portion of this connector set is configured with an annular conductor arrangement having a hollow center pin and typically has the same outside diameter (OD) with varying internal diameters (ID), for example, 2.1 mm, 2.3 mm or 2.5 mm. The corresponding connector portion of the Switchcraft 765/712 set—often referred to as a “jack” (e.g., the DC power jack 118 shown in FIG. 1)—includes a center pin that is arranged to slideably engage with the ID of the cylindrical plug to create a first power conducting path. The OD of the cylindrical plug slideably engages with a plug receiving portion of the DC power jack (often in a friction-fit type arrangement) to create a second power conducting path. The power conducting paths are used for power and ground paths where the particular polarity of the paths is a design choice of the AC-DC power adapter manufacturer.

As a result, as in the example above, a power adapter plug can be physically connected to an electrically incompatible product so long as its ID is the same size or larger than the OD of the pin of the DC power jack. However, because the plug and jack are at least mechanically compatible, the user may think that the AC-DC power adapter is, in fact, appropriate for the user's electronic device. That is, there is no clear feedback to the user that the AC-DC power adapter may be wrong other than the electronic device not operating properly or becoming damaged, or through that familiar electrical burning smell which rather strongly indicates that something really has gone wrong. By the time the user looks to the electrical specifications which are typically printed on a label on the AC-DC power adapter, finds the corresponding power requirements for the electronic device (i.e., nominal voltage, current and input polarity), and then determines that the AC-DC power adapter is the wrong one for the device, it may be too late and serious and irreversible problems with the electronic device or AC-DC power adapter may have already occurred.

The consequences of using the wrong AC-DC power adapter (i.e., one that is not designed for the specific electronic device with which the AC-DC power adapter is being used) are significant. A safety issue may be created if the use of a wrong AC-DC power adapter causes the electronic device (or the AC-DC power adapter itself) to generate excessive heat or catch fire; the electronic unit may be damaged and/or become inoperable; or the electronic device may not perform to specification.

Many typical electronic devices include certain design measures to address the above-noted safety issue for regulatory and product-liability reasons, among others. Some also employ circuits which provide some degree of electrostatic discharge (ESD) or electrical surge protection. However, while satisfactory in some applications, none of these schemes provide a capability to protect the electronic device from damage when a wrong AC-DC power adapter is plugged in, nor provide the user with straightforward and complete feedback that a chosen AC-DC power adapter is the right one for the electronic device.

### BRIEF DESCRIPTION OF THE DRAWING

FIG. 1 is a block diagram of a conventional AC-DC power adapter arrangement as practiced in the prior art;

FIG. 2 is a block diagram of a conventional implementation of a power circuit incorporating a DC power jack as practiced in the prior art;

FIG. 3 is a block diagram of an illustrative smart power connector with automatic power control; and

FIG. 4 is a block diagram of an illustrative smart power connector module.

### DETAILED DESCRIPTION

FIG. 2 is a block diagram of a conventional implementation of a power circuit 200 incorporating a DC power jack as practiced in the prior art. Jack 201 is arranged to couple an external power supply (such as an AC-DC power adapter not shown in FIG. 2) to a main circuit 295 of a typical electronic device such as a mobile telephone, portable music player, etc. Protection element 202 is arranged in parallel between positive and negative busses 203 and 205, as shown in FIG. 2. Protection element 202 provides ESD, surge, and over-voltage protection and is typically configured as a voltage-clamping device. Conventional power circuits may use one or more protection elements. In this example, a second protection element 210 is arranged in parallel with protection element 202 in power circuit 200.

Fuse 208 is arranged in series along bus 203. Fuse 208 provides over-current protection and is typically a one-time-fuse or a resettable fuse. In this example, fuse 208 is disposed between the protection elements 202 and 210.

Over-voltage and over-current is provided in the conventional implementation by using such fuse plus voltage clamping schemes shown in FIG. 2. When current in bus 203 exceeds a threshold, fuse 208 disconnects, either temporarily or permanently. During an over-voltage condition, excessive current may also pass through fuse 208 causing it to disconnect.

Conventional power circuits may prevent the electronic device containing main circuit 295 from becoming a safety hazard by catching on fire, but may not prevent the device from becoming damaged. For example, if a permanent fuse is used in the power circuit 200, once the fuse is permanently disconnected (i.e., “blown”), the electronic device will no longer function. Or, if the input voltage applied at jack 201 is too high due to the use of an incorrect AC-DC power adapter, the applied voltage may not be high enough to trip the protection elements 202 and/or 210 (which means no safety hazard is present), but the applied voltage may still be high enough to damage the main circuit 295. Conventional power circuit 200 also does nothing to prevent malfunctioning of the electronic device containing main power circuit 295 when an AC-DC power adapter is utilized that is out-of-specification and provides an under-voltage condition.

From the user's perspective, a conventional power circuit's indicator provides only limited information. Typically a single light emitting diode (LED) is utilized as a “Power LED” which lights to indicate that power has been applied to an electronic device. However, the Power LED does not indicate to the user whether the correct AC-DC power adapter is being used. In other words, the function of this Power LED is really limited.

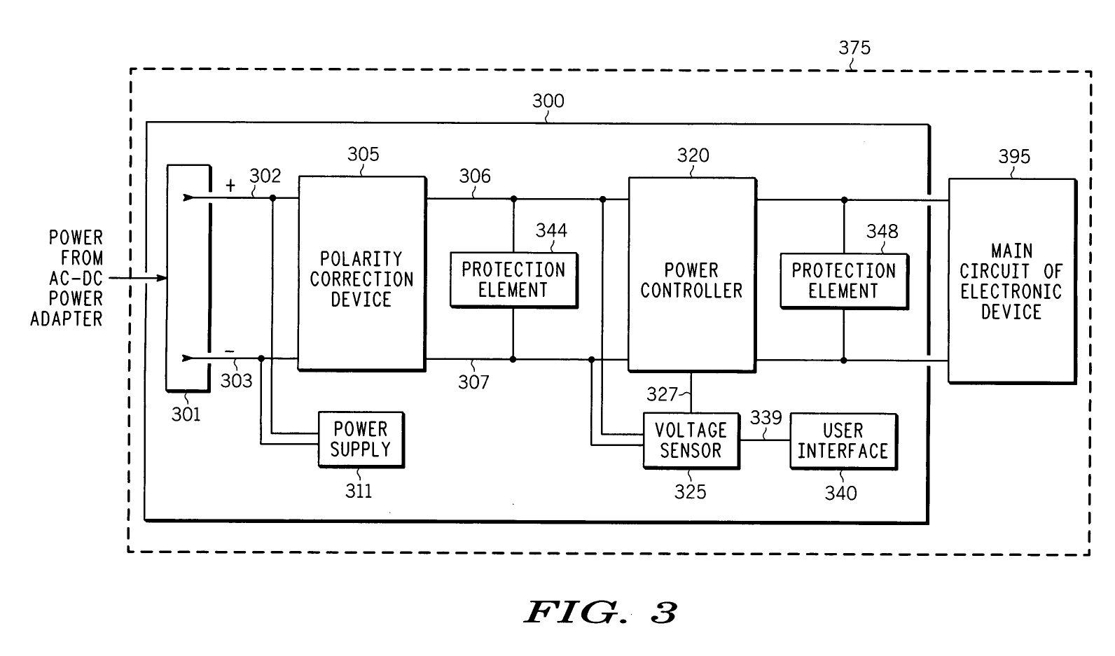

FIG. 3 is a block diagram of an illustrative “smart” power connector with automatic power control. A smart connector arrangement 300 is used to couple an external power supply (such as an AC-DC power adapter) to an electronic device's main circuit 395. The term “smart” is used here to refer to an structural arrangement that has an ability to sense aspects of the environment in which it operates and take action in response to changes in that environment. It is further emphasized that all electronic devices that use external power supplies to provide operating power to the device (or to charge on-board batteries) can utilize, and benefit from, a smart power connector as described herein.

Smart connector arrangement 300 is typically packaged separately from main circuit 395 so that existing main circuit designs may readily be upgraded with the additional protection and optional user-feedback features provided by the smart power connector. However, in applications where, for example, a new main circuit is designed, then smart connector 300 is combined with main circuit 395 as indicated by reference numeral 375 in FIG. 3. In such an approach, the circuits used to implement smart connector 300 use common packaging (in the case of an implementation using integrated circuits) or a common circuit board (in the case of an implementation using discrete components) with main circuit 395 of the electronic device.

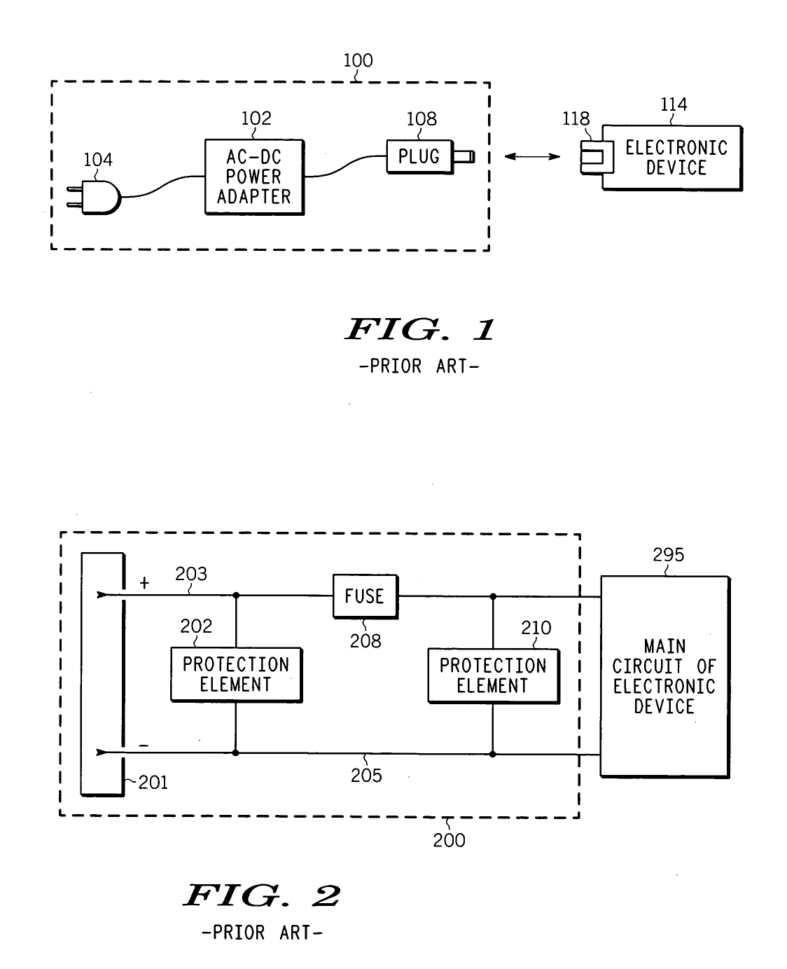

DC power jack 301 provides an interface to an AC-DC power adapter such as that indicated by reference numeral 100 in FIG. 1. DC power jack 301 is thus arranged to be removably engagable with a power adapter plug of an AC-DC power adapter. That is, power adapter plug 108 as shown in FIG. 1 and DC power jack 301 are configured as mating connectors and will typically include corresponding mechanical interfaces and electrical interfaces to thereby enable a DC power path to be established through the respective mated connecting elements. It is emphasized that the use of the terms “jack” and “plug” herein is arbitrary and is not intended as a limitation. Any set of mateable connectors may be used to realize the benefits and advantages of a smart power connector and either portion of a mateable connector set may be used for DC power jack 301 and power adapter plug 108, respectively, according to the requirements of the specific application.

The respective mateable connectors described above can take any of a variety of connector configurations including both friction fit (as with the Switchcraft brand 765/712 power plug/jack) or mechanically locking type connectors. For example, in some applications, a positive locking type connector is used where the engagement and/or disengagement of the jack and mateable plug require the actuation of a mechanism by the user such as a catch or latch.

Other connector types containing multiple circuit paths (where such circuit paths are typically used for purposes in addition to supplying power to an electronic device) are alternatively utilized. For example, mating connectors used in electronic devices that interact with docking equipment (e.g., docking “cradles”) often use multiple circuits to establish data/communications paths between the electronic device and the docking device. Electronic devices such as personal digital assistants and music players are often used with docking cradles to perform synchronization or other functions with a personal computer or other external apparatus. The electronic devices are typically simultaneously charged or powered through the docking cradle connector.

As shown in FIG. 3, DC power jack 301 includes two lines 302 and 303—one line functioning as a power conductor and one functioning as ground. Lines 302 and 303 are coupled to polarity correcting device 305. This device corrects for polarity of the DC voltage applied to DC power jack 301 when a power adapter plug 108 is coupled to connector 301 to thereby supply power from AC-DC power adapter (e.g., 100 in FIG. 1). Polarity correcting device 305 may alternatively disconnect power from connector 301 if it is the wrong polarity. Polarity correcting device 305 thus ensures that the polarity of the applied DC power will not cause damage to the main circuit 395 of the electronic device.

Polarity correcting device 305 is arranged from a variety of electronic devices, depending on the specific characteristics desired. For example, polarity correcting device 305 is alternatively arranged from conventional elements such as diodes, a bridge rectifier, MOS-FETs (metal-oxide-semiconductor field effect transistors), and the like.

Power supply 311 is coupled to connector 301 as shown in FIG. 3. Power supply 311 receives power from the external power supply (typically AC-DC power adapter 100 of FIG. 1) via connector 301. Power supply 311 distributes appropriate power to the various operative elements contained in the smart connector arrangement 300. Such power distribution is not illustrated in FIG. 3.

Power supply 311 taps power upstream of polarity correcting device 305 to ensure that power is supplied to the operative elements of arrangement 300, and in particular the user interface 340 (which is described in detail below) so that such operative elements can work normally even in the case when power is supplied from a reverse polarity AC-DC power adapter and polarity correcting device 305 is arranged to thereby disconnect power from connector 301. Accordingly, some or all of the operative elements of arrangement 300 may be optionally arranged from polarity-insensitive devices. In particular, it is generally preferable that the user interface 340 be configured so that it is powered even in the case where the input power applied to connector 301 is from a reversed polarity AC-DC power adapter. Being thus powered, user interface 340 is thereby capable of providing an alert to the user to indicate that the AC-DC power adapter is incorrect for the application.

Power controller 320 is coupled to polarity correcting device 305 via lines 306 and 307 as shown in FIG. 3. In this illustrative example, power controller 320 is arranged to perform a switching function to allow or disallow power to be passed to main circuit 395 in response to a control signal from the voltage sensor 325. In alternative arrangements, power controller 320 is arranged to perform an over-current protection function or voltage clamping function in a conventional manner.

Voltage sensor 325 is coupled to lines 306 and 307 to detect the polarity corrected voltage at the output of polarity correcting device 305. Voltage sensor 325 compares the detected voltage against a reference which defines operating specifications, for example nominal voltage plus a tolerance, for the main circuit 395. Such operating specifications are pre-defined for proper function of main circuit 395 by the designer or manufacturer of the main circuit 395 of the electronic device.

If the detected voltage exceeds the reference then voltage sensor 325 outputs a control signal to power controller on line 327. Power controller 320 performs a switching function to turn power off to main circuit 395 in response to the received control signal from voltage sensor 325 on line 327. Alternatively, power controller 320 is configured to clamp the voltage applied at its inputs to a specified operating level in response to the control signal from voltage sensor 325.

Voltage sensor 325, in this illustrative example, is implemented using a voltage comparator with associated logic circuits. The pre-defined reference sets a limit for the nominal operating voltage of main circuit 395 plus a tolerance limit. The voltage comparator compares the reference against the output voltage from the polarity correcting device 305 while making any correction necessary to offset the voltage drop across the polarity correction device 305. The reference is implemented using any of a number of techniques. For example, in this illustrative smart connector the reference is implemented as a voltage reference using a circuit comprising discrete zener and switching diodes (not shown in FIG. 3). However, other arrangements (such as look up table) may be utilized according to the specific requirements of an application.

As shown in FIG. 3, protection elements 344 and 348 are arranged in a parallel configuration between lines 306 and 307, and disposed on either side of power controller 320. Protection elements are optionally used depending on the specific requirements of the application. Protection elements 344 and 348 are configured to provide ESD, surge, and/or over-voltage protection and may comprise voltage-clamping devices.

User interface 340 is optionally used in the smart connector arrangement 300. User interface 340 is coupled to voltage sensor 325 via line 339 and provides easy-to-understand feedback so that the user immediately knows if the AC-DC power adapter plugged into an electrical device employing a smart power connector is compatible with the device or not. User interface 340 may be arranged from visual indicators (e.g. one or more light emitting diodes (LED) using one or more colors for the LED, or other information-communicating devices), audio indicators (e.g., buzzers or other tone generators), or a combination of both visual and audio indicators. In this illustrative example, user interface 340 comprises a set of LEDs in respective green, red and amber colors along with an audible indicator such as a buzzer.

The smart connector arrangement shown in FIG. 3 is preferably configured to be fully automatic in operation. Once a power adapter plug 108 (FIG. 1) from AC-DC power adapter 100 (FIG. 1) is plugged into the DC power jack 301, the arrangement 300 is configured to operate as described above without any other interaction from a user.

The operative elements shown in FIG. 3, including the polarity correction device 305, protection elements 344 and 348, voltage sensor 325, power controller 320, and user interface 340 are implemented using a variety of known ways. For example, the features and functions of a smart power connector may be implemented using discrete devices or integrated circuits (or a combination of both). Similarly, the voltage comparator function of voltage sensor 325 may be implemented using a standard, off-the-shelf voltage comparator, OPAMP (operational amplifier), or a portion, or all of an application specific integrated circuit (ASIC).

There are a variety of ways for voltage sensor 325, power controller 320 and user interface 340 to interoperate. Table 1, below, provides one illustrative example:

TABLE 1

| Input condition, | | | |
|---|---|---|---|
| as determined by voltage | Power Controller | User Interface, | Electronic Device |
| sensor | Switch status | Visual Indicator Status | Status |
| Input voltage at connector | On | Green LED on | Normal Operation |
| within specification | | | |
| Input voltage at connector | Off | Red LED on | Not working |
| above specification | | | |
| Input voltage at connector | On | Amber LED on | Electronic device |
| below specification | | | may or may not |
| | | | work - Amber |
| | | | LED is a warning |
| | | | to the user |

Table 2, below, provides another illustrative example of the interworking of operative elements including voltage sensor 325, power controller 320 and user interface 340 within smart connector 300.

TABLE 2

| Input condition, | | | |
|---|---|---|---|
| as determined by voltage | Power Controller | User Interface, | Electronic Device |
| sensor | Switch status | Visual Indicator Status | Status |
| Input voltage at connector | On | Green LED on | Normal Operation |
| within specification | | | |
| Input voltage at connector | Off | Red LED on/audible | Not working |
| above specification | | indicator on (e.g. buzzer) | |
| Input voltage at connector | Off | Amber LED flashing | Not working |
| below specification | | | |

The examples shown in Tables 1 and 2 illustrate the feedback feature where clear (i.e., unambiguous) indicators are provided to the user as to whether an AC-DC power adapter plugged into an electronic device is within an acceptable performance range.

Several significant form factors are alternatively utilized for the smart power connector. For example, a fully integrated connector may be packaged with the operative elements (and optional elements) shown in FIG. 3 and described in the accompanying text. The term “integrated” as used here means the collection of features including voltage sensing, power control and optional user interface functions combined with a connector (e.g., a DC power jack) to provide electrical and mechanical connection with a mateable connector disposed in the AC-DC power adapter plug, to thereby create the smart connector product. A smart connector manufacturer may choose specific implementations and combinations of features and optional functions depending upon the requirements of the application taking cost and other factors into account.

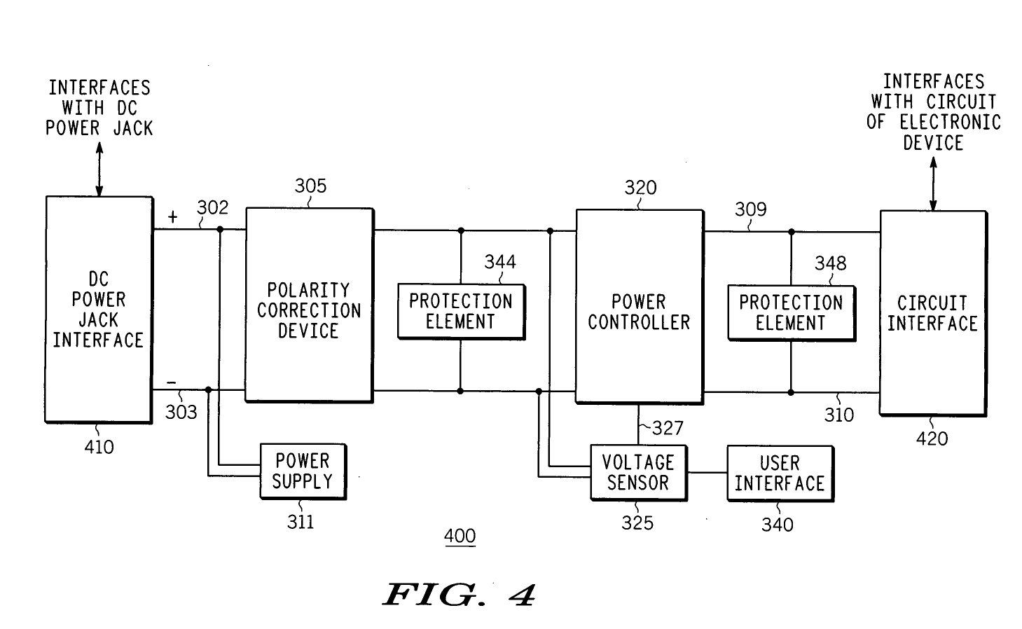

Another form factor for the smart power connector is shown in FIG. 4. There, a connector module 400 is formed by the addition of a connector interface 410 that is arranged to interface with DC power connector 301 and a circuit interface 420 that is arranged to interface with main circuit 395. Connector interface 410 is configured to be coupled to a connector such as a DC power jack. Other elements shown in FIG. 4 are similar in form and operation to those shown in FIG. 3 and described in the accompanying text.

The connector module is thereby arranged to provide voltage sensing, power control and optional user interface functions in a discrete, standalone device. The connector module may thus be readily incorporated, for example, into electronic devices on an original equipment manufacturer (OEM) basis to thereby facilitate ready modular integration between a DC power jack and the rest of the circuitry of the electronic device at hand. Similarly, the connector module can be sold to connector manufacturers for integration with traditional or standard connector products. The elements shown in FIG. 4 and described above in the text accompanying FIG. 3 are used to implement the connector module as shown, or alternatively may be implemented in an ASIC which may be desirable for some applications.

1. A smart connector, comprising:
a jack that is removably engagable with a respective mateable plug whereby a power path between a power supply and a circuit in an electronic device is established when the jack and mateable plug are mateably engaged,
a voltage sensor coupled to the jack for comparing voltage at the power path against a reference which defines a level of power that will operate the circuit without causing damage, and for outputting a control signal according to a result of the comparing; and,
a power controller coupled to the voltage sensor for controlling a flow of power to the circuit in response to the control signal.

2. The smart connector of claim 1 where the power controller comprises a switch.

3. The smart connector of claim 1 where the power controller comprises a current limiter.

4. The smart connector of claim 1 where the power controller comprises a voltage clamping device.

5. The smart connector of claim 1 further including a polarity correcting device for correcting polarity of the flow of power according to requirements of the circuit.

6. The smart connector of claim 1 further including an indicator for indicating to a user whether power supplied by the power supply is correct for the circuit upon engagement of the jack and mateable plug.

7. The smart connector of claim 6 where the indicator is a visual indicator.

8. The smart connector of claim 6 where the indicator is an audible indicator.

9. The smart connector of claim 1 where the jack includes a friction-fit mechanical interface.

10. The smart connector of claim 1 where the jack includes a positive-lock mechanical interface.

11. A method of operating an electronic device comprising the steps of:
engaging a jack in an electronic device to a respective mateable plug that is connected to a power supply to thereby establish a power path between the power supply and a circuit in the electronic device;
determining, with a power sensing circuit, whether power supplied by the power supply will operate the main circuit without damage; and,
controlling a flow of power along the power path to the circuit in response to a result from the determining step.

12. The method of claim 11 further including a step of indicating to a user a result of the determining step using a visual or audible indicator.

13. The method of claim 11 where the step of controlling comprises switching power to the circuit.

14. The method of claim 11 further including a step of inverting a polarity of the power flowing along the power path.

15. A smart connector module, comprising:
a housing;
a power jack interface coupled to the housing arranged to be connectable to a power jack; and
a voltage sensor coupled to the power jack interface and further coupled to the housing, the voltage sensor arranged to sense whether power applied to the power jack interface is within specification to enable operation of a circuit of an electronic device.

16. The smart connector module of claim 15 where the voltage sensor operates when a power supply is coupled to the jack using a mateable plug connected to the power supply.

17. The smart connector module of claim 15 further including a power controller coupled to the voltage sensor for controlling a flow of power to the circuit in response to operation of the voltage sensor.

18. The smart connector module of claim 17 where the power controller includes a switch to switch power on and off to the circuit.

19. The smart connector module of claim 16 further including a circuit interface disposed in the housing and coupled to the power controller, the interface being arranged to be connectable to the circuit.

20. The connector module of claim 16 further including an indicator for indicating to a user whether power supplied by the power supply is correct for the circuit upon engagement of the jack and the mateable plug.
